(19) United States
(12) Patent Application Publication
(10) Pub. No.: US 2007/0089826 A1
(43) Pub. Date: Apr. 26, 2007

(54) Method for producing a multilayer printed wiring board

(75) Inventors: Yukihiro Ueno, Hiroshima (JP); Yuhji Takamoto, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/580,892

(22) Filed: Oct. 16, 2006

(30) Foreign Application Priority Data
Oct. 17, 2005 (JP) 2005-301840

(51) Int. Cl. B32B 37/00; B32B 38/10

(52) U.S. Cl. 156/64; 156/247; 156/267; 156/272.8

(57) ABSTRACT

A method for producing a multilayer printed wiring board includes an inner layer formation step of forming an inner layer pattern in a core substrate divided corresponding to a flexible portion that is made bendable and a hard portion that is made rigid, and an outer layer formation step of forming an outer layer such that an outer layer material that covers the core substrate is caused to make contact at the hard portion, and an outer layer pattern formation step of forming an outer layer pattern in the surface of the outer layer material, and a removal step of removing a covering portion that is the outer layer material and is covering the flexible portion, and an outer shape formation step of forming the outer shape of a layered substrate formed via the removal step. Also, an inner layer protection pattern is formed in the periphery of the flexible portion before the outer layer formation step, and the method is provided with a step of severing the periphery of the covering portion by irradiating a laser beam on the outer layer material that corresponds to the inner layer protection pattern before the removal step.

### BACKGROUND OF THE INVENTION

This application claims priority under 35 U.S.C. § 119(a) on Japanese Patent Application No. 2005-301840 filed in Japan on Oct. 17, 2005, the entire contents of which are hereby incorporated by reference.

The present invention relates to a method for producing a multilayer printed wiring board that includes a process in which a portion of an outer layer material is removed.

In portable electronic devices such as video cameras or digital cameras, because it is necessary to dispose many electronic components in a small space inside and connect these electronic components by wiring them to each other, multilayer printed wiring boards that can be bent are used. Here, a method for producing a bendable multilayer printed wiring board will be described with reference to the accompanying drawings.

FIG. 13 is a cross-sectional diagram of a core substrate in a conventional method for producing a multilayer printed wiring board. A core substrate 100 is configured with conductor layers 111 and 112 layered on both faces of a flexible insulating resin film 110.

FIG. 14 is a cross-sectional diagram of a core substrate in which an inner layer pattern has been formed, in a conventional method for producing a multilayer printed wiring board. In one face of the core substrate 100, using for example an etching method, an inner layer pattern 120 is formed, and the conductor layer 112 is left remaining on the other face. The core substrate 100 in which the inner layer pattern 120 has been formed is divided into a flexible portion 122 that is made bendable and a hard portion 121 that is made rigid. The flexible portion 122 is a portion in which an outer layer material 150 is not layered and thus is made bendable (see FIG. 16), and the hard portion 121 is a portion in which the outer layer material 150 is layered and is thus made rigid.

FIG. 15 is a cross-sectional diagram of a core substrate in which a coverlay film has been layered, in a conventional method for producing a multilayer printed wiring board. In the face in which the inner layer pattern 120 has been formed, in order to protect the inner layer pattern 120, a coverlay film 141 is layered via an adhesive 131. The coverlay film 141 is a flexible insulating film, and so flexibility is maintained in the core substrate 100 in which the coverlay film 141 has been layered.

FIG. 16 is a cross-sectional diagram of a layered substrate in which an outer layer material has been layered, in a conventional method for producing a multilayer printed wiring board. The outer layer material 150 is configured with a conductor layer 151 layered on the surface of a hard insulating substrate 152. Also, in the outer layer material 150, a slit (a narrow rectangular through-hole) 155 is formed in advance in a portion that corresponds to a border DL 1 of the flexible portion 122 and the hard portion 121.

The outer layer material 150 is layered via an adhesive 132 on the face in which the inner layer pattern 120 has been formed, such that the conductor layer 151 is disposed on the top face. Thus, a layered substrate 102 is formed as an intermediate body.

When layering the outer layer material 150 using adhesive, the adhesive 132 is not applied to the flexible portion 122. Accordingly, the outer layer material 150 and the flexible portion 122 are not bonded. On the other hand, portions other than the outer layer material 150 and the flexible portion 122 (i.e., the hard portion 121) are in a bonded state.

FIG. 17 is a cross-sectional diagram of a layered substrate in which an outer layer pattern has been formed in an outer layer material, in a conventional method for producing a multilayer printed wiring board. After the outer layer material 150 has been layered, for example, through-hole processing (not shown), panel plating, formation of an outer layer pattern 154, silk printing, plating processing, and rust-prevention processing are performed.

FIG. 18 is a top view of a layered substrate in which an outer layer pattern has been formed in an outer layer material, in a conventional method for producing a multilayer printed wiring board. After forming the outer layer pattern 154, an outer shape is formed by shearing the layered substrate 102 along an outer shape line DL 2 that defines the outer shape of the completed component (a multilayer printed wiring board 103). At this time, the periphery of a covering portion 158 is sheared.

Next, the covering portion 158 is peeled away. The periphery of the covering portion 158 is severed, the border DL 1 with the hard portion 121 is divided by the slit 155, and the rear face of the covering portion 158 is not bonded with the core substrate 100, so the covering portion 158 is physically independent. Thus, the covering portion 158 can be peeled away.

Instead of forming the slit 155 of the outer layer material 150, a concave portion may be formed on the side on which the adhesive 132 is applied. In this case, it may be that the adhesive 132, which bonds the core substrate 100 and the outer layer material 150, penetrates into the concave portion, so that in the concave portion the outer layer material 150 cannot be peeled away. Thus, methods have been proposed in which a coverlay is applied in advance to the concave portion such that the adhesive does not enter the concave portion (for example, JP 2003-31950A (hereinafter referred to as Patent Document 1)).

After the covering portion 158 is peeled away, a flexible multilayer printed wiring board is completed by performing electrical testing or the like.

Incidentally, although the covering portion is not bonded to the core substrate with the adhesive, heat or pressure is applied when layering the coverlay film or the outer layer material in the production process of the multilayer printed wiring board, and so the covering portion is closely fitted to the core substrate. Thus, the covering portion is difficult to peel away.

In a conventional method for producing a multilayer printed wiring board or the production method according to Patent Document 1, in a state after the outer shape has been formed, that is, in a state in which the flexible portion is in a cantilever state at the border with the hard portion and is easily bent, the closely fitted covering portion is peeled away, and so when making the initial separation, the flexible portion may be bent or deformed, or ripples may be caused in the peripheral portion of the flexible portion. Also, it may be that damage occurs at the border with the hard portion due to stress being concentrated on the border, due to a deformation or the like of the flexible portion, and so there may be a decrease in flexibility properties (tolerance to repeated mobility testing in a bent state).

For the same reason, during the peeling away as well, the flexible portion may be bent or deformed, or ripples may be caused in the peripheral portion of the flexible portion, or the flexibility properties may decrease.

Thus, it is necessary to carefully perform the work of peeling away, so this work takes very much time.

Also, after forming the outer shape, the covering portion is peeled away and work such as electrical testing is performed, so there are many opportunities for external force to be exerted on the flexible portion, and the flexible portion may be damaged or bent.

Also, when forming a card edge-type terminal in the flexible portion, when damage, bends, wrinkles, or the like are caused in the terminal, poor connections often occur in the connection to the connector. Therefore it is necessary to perform the peeling away work while being careful that such damage, bends, wrinkles, or the like do not occur, so this work takes very much time.

The present invention was made in view of such circumstances, and it is an object thereof to provide a method for producing a multilayer printed wiring board in which damage or the like is not caused when peeling away the covering portion.

### SUMMARY OF THE INVENTION

In order to address the above problems, the method for producing a multilayer printed wiring board according to the present invention includes an inner layer formation step of forming an inner layer pattern in a core substrate divided corresponding to a flexible portion that is made bendable and a hard portion that is made rigid, and an outer layer formation step of forming an outer layer such that an outer layer material that covers the core substrate is caused to make contact at the hard portion, and an outer layer pattern formation step of forming an outer layer pattern in the surface of the outer layer material, and a removal step of removing a covering portion that is the outer layer material and is covering the flexible portion, and an outer shape formation step of forming the outer shape of a layered substrate formed via the removal step; in which an inner layer protection pattern is formed in the periphery of the flexible portion before the outer layer formation step, and the method includes a step of severing the periphery of the covering portion by irradiating a laser beam on the outer layer material that corresponds to the inner layer protection pattern before the removal step.

With this configuration, it is possible to produce a multilayer printed wiring board without causing deformation or damage to the flexible portion. Specifically, the covering portion can be peeled away without causing deformation or damage to the flexible portion. That is, because the covering portion is peeled away before forming the outer shape, peeling away work can be performed in a state in which the flexible portion is held by the outer frame (the portion removed when forming the outer shape), so there is diminished opportunity for external force to be applied to the flexible portion, deformation of or damage to the flexible portion is not caused, and a decrease in flexibility properties is suppressed.

The flexible portion is a portion in which the outer layer material is not bonded, and is more easily flexed than the hard portion in which the outer layer material is bonded.

Also, in the method for producing a multilayer printed wiring board according to the present invention, in the above method, the inner layer protection pattern may be formed along with the inner layer pattern in the inner layer formation step. With this configuration, it is possible to form the inner layer protection pattern in the same step as the inner layer pattern, so manufacturing efficiency improves.

Also, in the method for producing a multilayer printed wiring board according to the present invention, in the above method, the inner layer protection pattern may be provided outside an outer shape line that defines the outer shape.

With this configuration, the inner layer protection pattern is formed outside of the outer shape line, so the inner layer pattern formed inside the outer shape line is not damaged. That is, with this configuration, the periphery of the covering portion (the portion of the outer layer material that corresponds to the inner layer protection pattern, and is severed by the laser beam) is located outside of the outer shape line. Accordingly, even when damage is caused at the peeling start end (periphery of the covering portion) where peeling is started when peeling away the covering portion, there is rarely an instance in which damage reaches inside of the outer shape line. Also, this damage is removed in the outer shape formation process, so the exterior state of the completed component is good.

Also, in the method for producing a multilayer printed wiring board according to the present invention, in the inner layer formation step, a testing pattern may be formed between the inner layer protection pattern and the outer shape line.

With this configuration, a testing pattern is disposed outside of the outer shape line of the manufactured good, so it is possible to reduce the size of the multilayer printed wiring board (the outer shape of the manufactured good) as a completed component. Also, it becomes unnecessary to fit the testing pattern within the bounds of the outer shape, so the testing pattern can be made a size at which electrical testing can easily be performed. Because in this manner it is possible to set an appropriate size for the testing pattern, it is possible to choose (possible to use) a probe pin of an appropriately suitable size, and it is possible to stably and swiftly perform electrical testing.

That is, when the testing pattern is provided inside the outer shape line, it is necessary to reduce the size of the testing pattern, so it is necessary to reduce the size of the probe pin used for electrical testing. Also, when a probe is placed in contact with the pattern or terminal directly without forming the testing pattern, and pattern width of the tested portion is narrow, it is necessary to use a small probe pin. The durability of a small probe pin is poor, so there is the problem that it is changed with high frequency. Also, there is the problem that because contact resistance or the like with the tested object is high, stability, speed and reliability of testing are poor. Moreover, precise positioning is necessary when testing a high density pattern, so there is the problem that stability, speed and reliability of testing are poor. However, by providing the testing pattern outside of the outer shape line restrictions on the size of the testing pattern are alleviated, so the testing pattern can be set to an appropriate size, and thus, it is possible to use a probe pin that has an appropriately suitable size. As a result, it is possible to reduce exchanges of the probe pin, and testing can be performed stably and swiftly.

Also, in the method for producing a multilayer printed wiring board according to the present invention, in the outer layer formation step, an outer layer guide pattern parallel to a border of the hard portion and the flexible portion may be formed in one or both of a side of the hard portion and a side of the flexible portion. With this configuration, it is possible to remove the covering portion along the border. As a result, when peeling away the covering portion there is no risk of peeling away the outer layer material of the hard portion.

Also, in the method for producing a multilayer printed wiring board according to the present invention, the outer layer protection pattern may be formed along with the outer layer pattern in the outer layer formation step. With this configuration, it is possible to form the outer layer protection pattern in the same step as the outer layer pattern, so manufacturing efficiency improves.

Also, in the method for producing a multilayer printed wiring board according to the present invention, before the removal step, a peeled portion may be formed in which the flexible portion and the covering portion have been separated by peeling. With this configuration, it is possible to simply start peeling away the covering portion from the peeled portion.

Also, in the method for producing a multilayer printed wiring board according to the present invention, electrical testing may be performed before the outer shape formation step. With this configuration, it is possible to perform electrical testing in the state before the outer shape is formed, that is, a state in which the flexible portion is held by the outer frame (the portion that is the hard portion and is removed by the outer shape formation step), so because there is no bending or damage while performing work, yield improves. Also, work to arrange in an electrical tester smoothly proceeds, improving work efficiency. As a result, electrical testing is smoothly performed, and during electrical testing there is no damage to the flexible portion.

Also, in the method for producing a multilayer printed wiring board according to the present invention, in the above method, a configuration may be adopted in which a plurality of the inner layer patterns are formed, and the inner layer protection pattern for each inner layer pattern is formed such that a portion is shared among adjacent inner layer protection patterns.

With this configuration, when a plurality of multilayer printed wiring boards are formed from one core substrate, it is possible to shorten the work time for severing with a laser beam. That is, when a plurality of multilayer printed wiring boards are formed from one core substrate, when the periphery of the covering portion is severed with a laser beam, it is necessary to scan the laser beam along each inner layer protection pattern, but by sharing a portion of adjacent inner layer protection patterns, it is possible to shorten the distance scanned by the laser beam, and the time for sever processing can be shortened.

### BRIEF DESCRIPTION OF THE DRAWINGS

FIG. 1 is a cross-sectional diagram of a core substrate in a method for producing a multilayer printed wiring board according to Embodiment 1 of the present invention.

FIG. 2 is a cross-sectional diagram of a core substrate in which an etching resist has been layered on both faces, in a method for producing a multilayer printed wiring board according to Embodiment 1 of the present invention.

FIG. 3 is a cross-sectional diagram of a core substrate in which an inner layer pattern has been formed, in a method for producing a multilayer printed wiring board according to Embodiment 1 of the present invention.

FIG. 4 is a top view of a core substrate in which an inner layer pattern has been formed, in a method for producing a multilayer printed wiring board according to Embodiment 1 of the present invention.

FIG. 5 is a cross-sectional diagram of a core substrate in which a coverlay film has been layered, in a method for producing a multilayer printed wiring board according to Embodiment 1 of the present invention.

FIG. 6 is a cross-sectional diagram of a layered substrate in which an outer layer material has been layered, in a method for producing a multilayer printed wiring board according to Embodiment 1 of the present invention.

FIG. 7 is a cross-sectional diagram of a layered substrate in which an outer layer pattern has been formed in an outer layer material, in a method for producing a multilayer printed wiring board according to Embodiment 1 of the present invention.

FIG. 8 is a top view of a layered substrate in which an outer layer pattern has been formed in an outer layer material, in a method for producing a multilayer printed wiring board according to Embodiment 1 of the present invention.

FIG. 9 is a cross-sectional diagram of a layered substrate in which a covering portion has been peeled away, in a method for producing a multilayer printed wiring board according to Embodiment 1 of the present invention.

FIG. 10 is a top view of a core substrate in a state in which a plurality of inner layer patterns have been formed, in a method for producing a multilayer printed wiring board according to Embodiment 2 of the present invention.

FIG. 11 is an enlarged view of adjacent portions of a multilayer printed wiring board that have been disposed vertically in FIG. 10.

FIG. 12 is an enlarged view of the vicinity of terminals that have been provided in a flexible portion, in a method for producing a multilayer printed wiring board according to Embodiment 3 of the present invention.

FIG. 13 is a cross-sectional diagram of a core substrate in a conventional method for producing a multilayer printed wiring board.

FIG. 14 is a cross-sectional diagram of a core substrate in which an inner layer pattern has been formed, in a conventional method for producing a multilayer printed wiring board.

FIG. 15 is a cross-sectional diagram of a core substrate in which a coverlay film has been layered, in a conventional method for producing a multilayer printed wiring board.

FIG. 16 is a cross-sectional diagram of a layered substrate in which an outer layer material has been layered, in a conventional method for producing a multilayer printed wiring board.

FIG. 17 is a cross-sectional diagram of a layered substrate in which an outer layer pattern has been formed in an outer layer material, in a conventional method for producing a multilayer printed wiring board.

FIG. 18 is a top view of a layered substrate in which an outer layer pattern has been formed in an outer layer material, in a conventional method for producing a multilayer printed wiring board.

### DESCRIPTION OF THE PREFERRED EMBODIMENTS

Hereinafter, a method for producing a multilayer printed wiring board according to embodiments of the present invention will be described with reference to the accompanying drawings.

### Embodiment 1

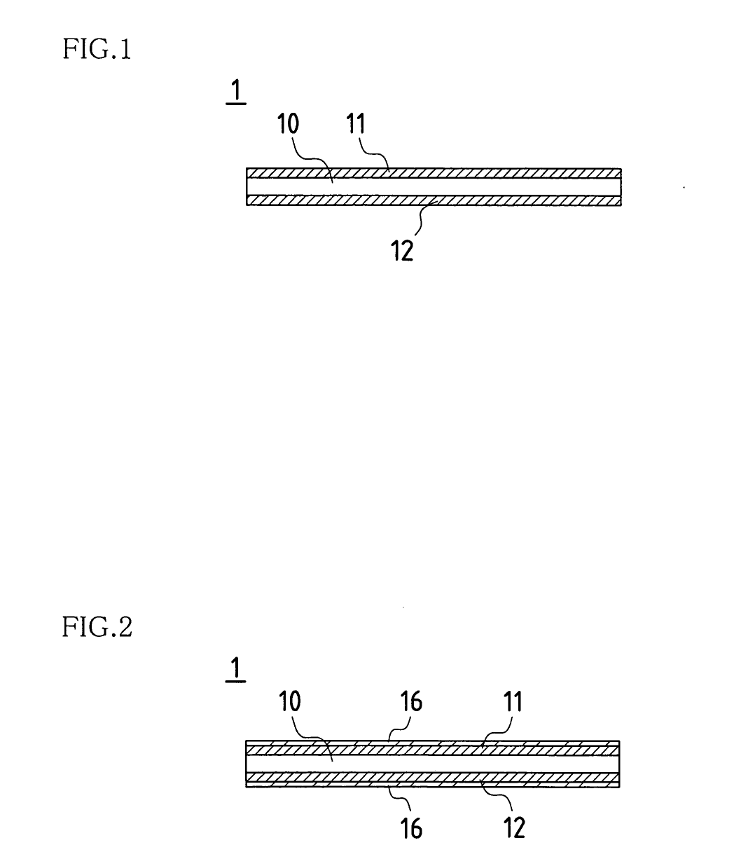

In the present embodiment, a method for producing a multilayer printed wiring board will be described with reference to FIGS. 1 to 9.

FIG. 1 is a cross-sectional diagram of a core substrate in a method for producing a multilayer printed wiring board according to Embodiment 1 of the present invention. A core substrate 1 is configured with conductor layers 11 and 12 layered on both faces of a flexible insulating resin film 10 via an adhesive. The insulating resin film 10 is formed from flexible polyimide resin, polyether ketone, liquid crystal polymer resin, or the like. Copper foil is used in the conductor layers 11 and 12. The conductor layers 11 and 12 may also be formed with a metal foil or the like other than copper foil. Also, the insulating resin film 10 may be formed with a method in which metal foil that becomes the conductor layers 11 and 12 is not bonded with adhesive (for example, such as a casting method).

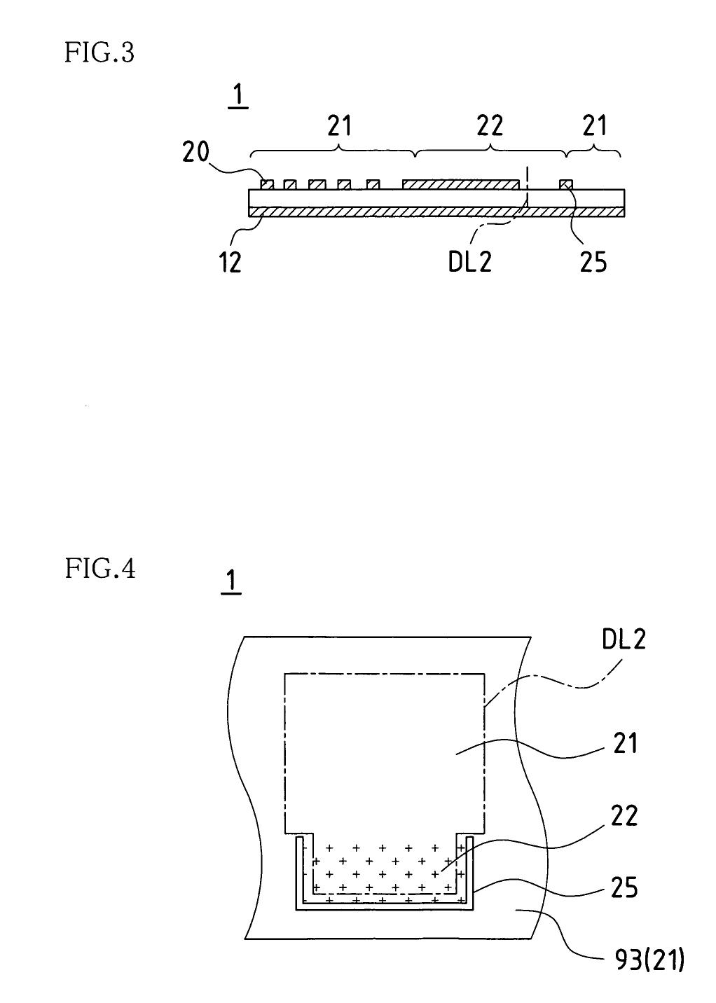

FIG. 2 is a cross-sectional diagram of a core substrate in which an etching resist 16 has been layered on both faces, in a method for producing a multilayer printed wiring board according to Embodiment 1 of the present invention. FIG. 3 is a cross-sectional diagram of a core substrate in which an inner layer pattern has been formed, in a method for producing a multilayer printed wiring board according to Embodiment 1 of the present invention. FIG. 4 is a top view of a core substrate in which an inner layer pattern has been formed, in a method for producing a multilayer printed wiring board according to Embodiment 1 of the present invention.

An inner layer pattern 20 is formed with an etching method. First, the etching resist 16 is layered on both faces of the core substrate 1. Next, the etching resist 16 in the face in which the inner layer pattern 20 is formed (the top face in the drawings) is patterned with a photolithography method and etched with an etching solution, and the etching resist 16 is removed, thus forming the inner layer pattern 20 (an inner layer pattern formation process). The inner layer pattern 20 may also be formed with, for example, an additive method, or a printing method in which the inner layer pattern 20 is formed using a conducting paste or the like.

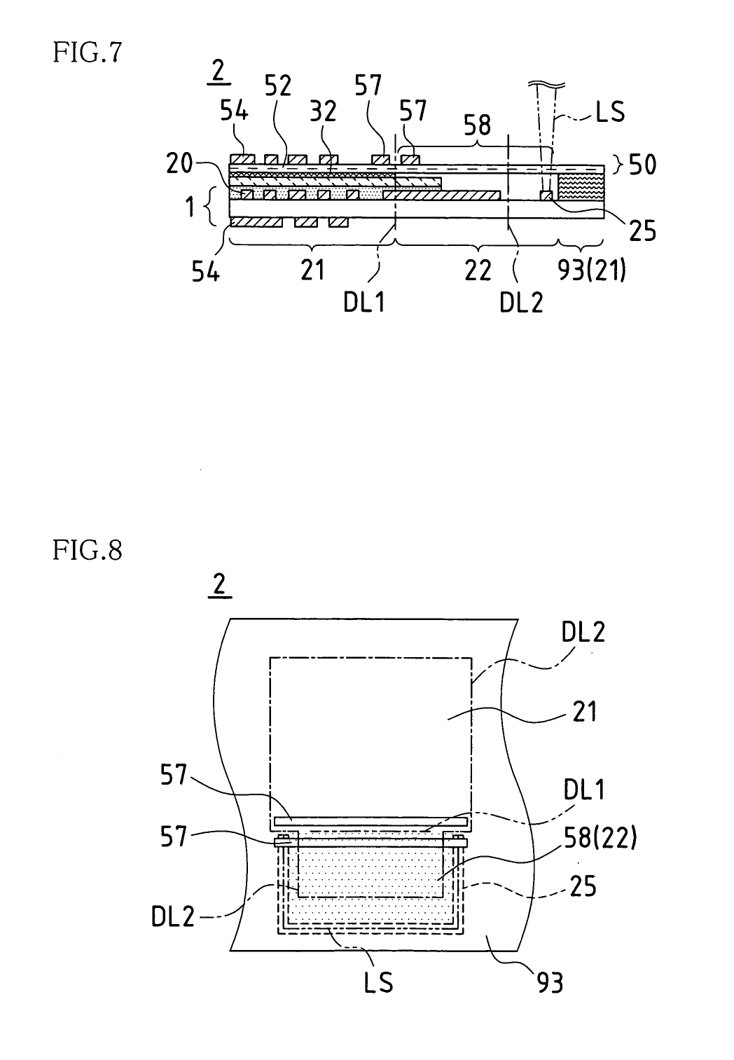

On the other hand, the etching resist 16 in the face in which the inner layer pattern 20 is not formed (the bottom face in the drawings) undergoes etching processing in a state in which it has not been patterned. That is, the bottom face side of the core substrate 1 remains as-is with copper foil. The copper foil on the bottom face side is processed during formation of an outer layer pattern 54 (see FIG. 7) performed later.

The core substrate 1 in which the inner layer pattern 20 has been formed is divided into a region that will become a flexible portion 22 (the shaded region in FIG. 4) and a region that will become a hard portion 21. The flexible portion 22 is a portion in which an outer layer material 50 (see FIG. 6) is not layered and thus is made bendable, and the hard portion 21 is a portion in which the outer layer material 50 is layered and thus is made rigid. An outer shape line DL 2 that defines the outer shape of the completed component (the multilayer printed wiring board) is set in the core substrate 1. The outer shape line DL 2 is set such that it basically surrounds the outside of the inner layer pattern 20. The outside of the outer shape line DL 2 (including an outer frame 93) is ultimately removed by shearing. In the production process, the outer layer material 50 is layered in the outer frame 93, so this region becomes the hard portion 21.

Also, in the inner layer pattern formation process, an inner layer protection pattern 25 is formed. The inner layer protection pattern 25 is formed in the periphery of the flexible portion 22, and is formed such that it surrounds the outer shape line DL 2. The inner layer protection pattern 25 has a function to protect such that the core substrate 1 is not severed when later severing the outer layer material 50 with a laser beam LS (see FIG. 7). Thus, the width of the inner layer protection pattern 25 is set somewhat larger than the laser spot. The inner layer pattern 20 and the inner layer protection pattern 25 are patterned at the same time, so it is not necessary to further increase the number of processes and the inner layer protection pattern 25 is effectively formed.

Also, the inside line of the inner layer protection pattern 25 is formed uniform with the outer shape line DL 2, or formed separated approximately 0.3 mm to 0.5 mm from the outer shape line DL 2. That is, when shearing along the outer shape line DL 2, the inner layer protection pattern 25 is severed and removed with the outer frame 93. The space between the inside line and the outer shape line DL 2 of the inner layer protection pattern 25 may be set within a wide range, such that damage does not reach the inside of the outer shape line DL 2 when peeling away the outer layer material 50 formed on the flexible portion 22. For example, a space of several millimeters may be set.

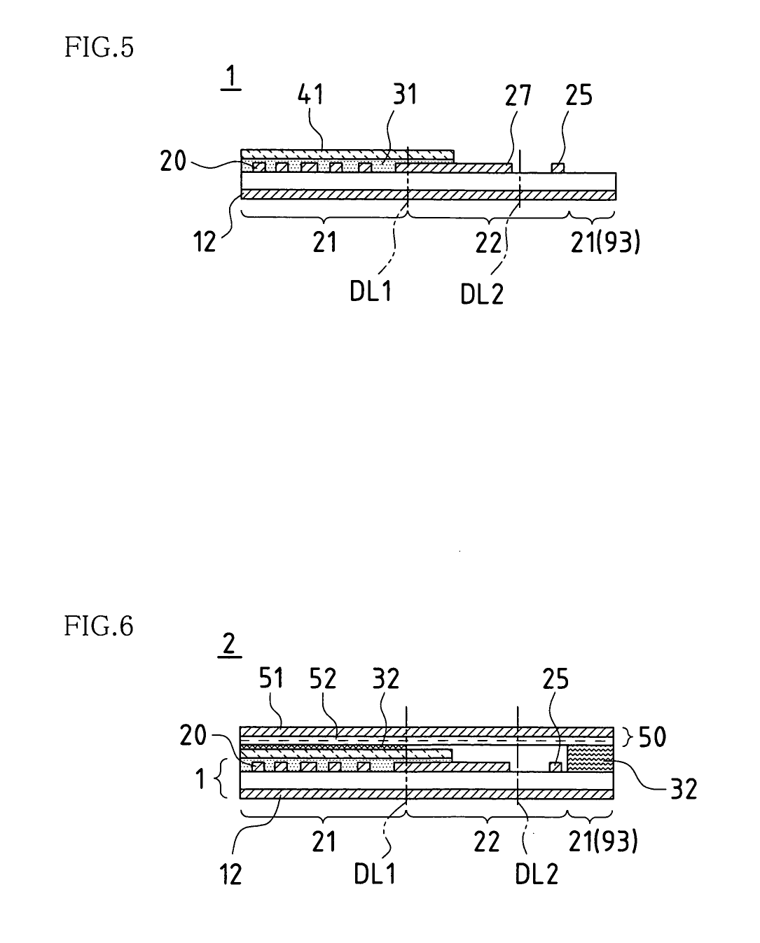

FIG. 5 is a cross-sectional diagram of a core substrate in which a coverlay film has been layered, in a method for producing a multilayer printed wiring board according to Embodiment 1 of the present invention. On the top face of the inner layer pattern 20, a coverlay film 41 is layered via an adhesive 31, in order to protect the surface of the inner layer pattern 20, and to insulate the surface of the inner layer pattern 20 from the outer layer pattern 54 formed later (see FIG. 7). The coverlay film 41 is a flexible insulating resin film, and the same material is used as the insulating resin film 10 from which the core substrate 1 is configured. Thus, flexibility is maintained for the core substrate 1 in which the coverlay film 41 is layered. For example, flexible polyimide resin, polyether ketone, liquid crystal polymer resin, or the like is used for the coverlay film 41.

When a terminal 27 is formed in the flexible portion 22, the terminal 27 is exposed due to not being covered by the coverlay film 41. In this step, surface processing such as metal plating is performed for the terminal 27 in order to have good rust-proofing and make a good connection.

FIG. 6 is a cross-sectional diagram of a layered substrate in which an outer layer material has been layered, in a method for producing a multilayer printed wiring board according to Embodiment 1 of the present invention. The outer layer material 50 is configured with a conductor layer 51 layered on the surface of an insulating substrate 52. The insulating substrate 52 is formed with a hard glass epoxy or polyimide. The conductor layer 51 is configured from copper foil or the like.

In the outer layer formation process, first, an adhesive 32 is applied to the hard portion 21 on the face in which the inner layer pattern 20 has been formed. That is, the adhesive 32 is applied in the region other than the flexible portion 22 (including the outer frame 93). Next, the outer layer material 50 is arranged such that it covers the entire core substrate 1, and layered by applying heat or pressure, forming a layered substrate 2 as an intermediate body. The conductor layer 51, which is formed on the surface of the outer layer material 50, is layered such that it is arranged on the outside. Accordingly, in the hard portion 21 (including the outer frame 93) the outer layer material 50 is layered using the adhesive 32, so the hard portion 21 is comparatively hard. On the other hand, in the flexible portion 22, a bond with the outer layer material 50 is not made by the adhesive 32, so the outer layer material 50 is only in contact. In FIG. 6, the flexible portion 22 and the outer layer material 50 are shown not in contact, but they are shown in this way in order to make it clear that the adhesive 32 is not applied. In actuality, heat and pressure are applied when layering in the production process, so the flexible portion 22 and the outer layer material 50 are both in a state of contact.

Also, in the outer layer formation process an outer layer may be formed without applying the adhesive 32. For example, the outer layer may be formed by layering the outer layer material 50, in which a heat sensitive adhesive layer (thermocompression adhesive layer) has been formed in a portion that corresponds to the hard portion 21.

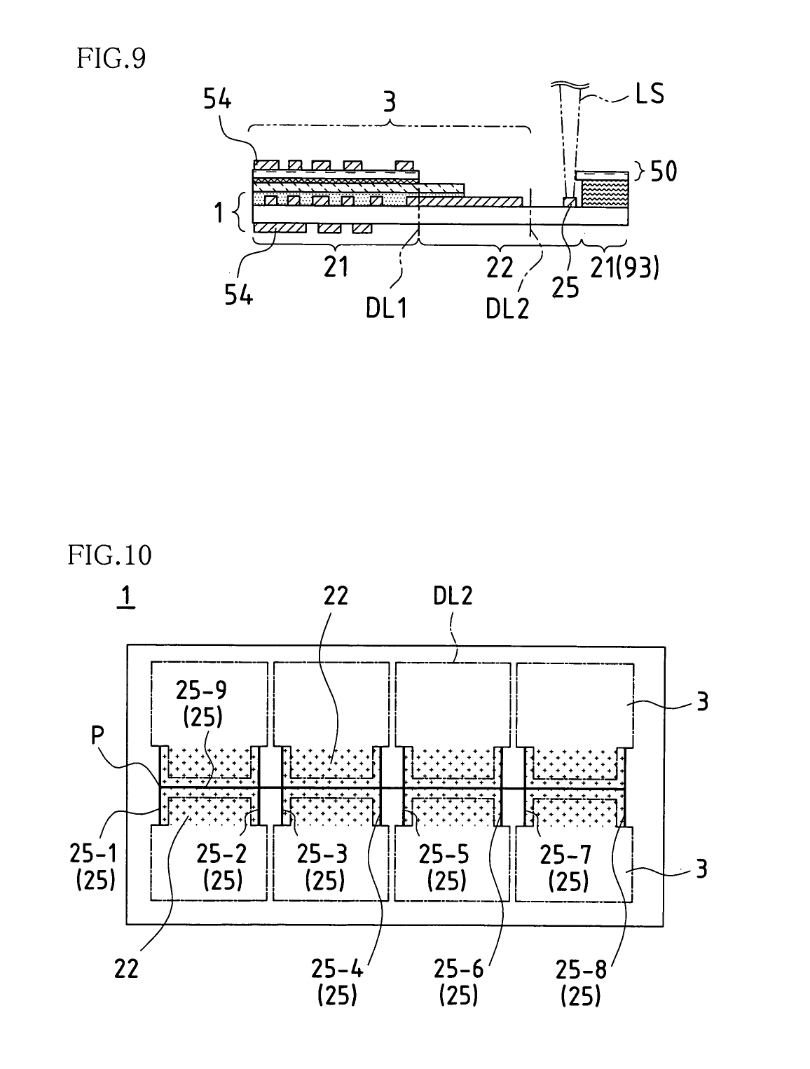

FIG. 7 is a cross-sectional diagram of a layered substrate in which an outer layer pattern has been formed in an outer layer material, in a method for producing a multilayer printed wiring board according to Embodiment 1 of the present invention. FIG. 8 is a top view of a layered substrate in which an outer layer pattern has been formed in an outer layer material, in a method for producing a multilayer printed wiring board according to Embodiment 1 of the present invention. FIG. 9 is a cross-sectional diagram of a layered substrate in which a covering portion has been removed, in a method for producing a multilayer printed wiring board according to Embodiment 1 of the present invention.

After the outer layer material 50 has been layered, through-hole processing (not shown), panel plating, formation of the outer layer pattern 54 (outer layer pattern formation process), silk printing, plating processing, rust-proofing processing, and the like are performed. In the outer layer pattern formation process, the outer layer pattern 54 is formed on both faces (the top face of the outer layer material 50 and the bottom face of the core substrate 1) of the layered substrate 2 with an etching method, for example. The outer layer pattern 54 may be formed with, for example, an additive method, or a printing method in which the outer layer pattern 54 is formed using conductive paste or the like.

In the same process, an outer layer guide pattern 57 is formed approximately parallel to a border DL 1 of the flexible portion 22 and the hard portion 21. The outer layer guide pattern 57 has a function to guide such that when afterward peeling away the outer layer material 50 (a covering portion 58) that covers the flexible portion 22, severing is reliably performed along the border DL 1 of the flexible portion 22 and the hard portion 21. The outer layer guide pattern 57 is formed by being patterned at the same time as the outer layer pattern 54, so no separate, new process is required.

The outer layer guide pattern 57 may be provided in one of the side of the flexible portion 22 and the side of the hard portion 21, or it may be provided in both. Also, both ends of the outer layer guide pattern 57 extend somewhat outside from the border DL 1.

After forming the outer layer pattern 54, the outer layer material 50 is severed by irradiating the laser beam LS on the outer layer material 50 at a position that corresponds to the inner layer protection pattern 25. The inner layer protection pattern 25 is formed with copper foil or the like, and is therefore less easily melted with the laser beam LS than resin, so only the outer layer material 50 is severed.

Next, the covering portion 58 that covers the flexible portion 22 is peeled away (a removal process). The covering portion 58 is not bonded to the core substrate 1, and its periphery is severed by the laser beam LS, so the covering portion 58 can be peeled away starting from its periphery (the portion severed by the laser beam LS). Also, the outer layer guide pattern 57 is formed at the border DL 1 of the flexible portion 22 and the hard portion 21, so it is possible to peel away the covering portion 58 and sever (break off, or tear off) along the outer layer guide pattern 57, and thus the covering portion 58 is completely removed. Both ends of the outer layer guide pattern 57 extend somewhat outside from the border DL 1, and overlap the scanning line of the laser beam LS, so the covering portion 58 is severed along the border DL 1 when peeling away of the covering portion 58 reaches the border DL 1.

At this time, the outer frame 93 is left remaining at the circumference of the flexible portion 22, and the flexible portion 22 is held by the outer frame 93. Accordingly, there is almost no opportunity for external force to be applied to the flexible portion 22, and so deformation of or damage to the flexible portion 22 does not occur, and flexibility properties do not decrease. That is, it is possible to peel away the covering portion 58 without bending the flexible portion 22, so the flexible portion 22 is not deformed or damaged. Also, because the flexible portion 22 is not deformed, stress is not concentrated on the border DL 1, so flexibility properties are not decreased.

Also, the outer layer guide pattern 57 prevents peeling away past the border DL 1, so there is no peeling away as far as the outer layer material 50 of the hard portion 21. Also, in the vicinity of the border DL 1, the occurrence of cracks caused by severing is prevented.

Also, when the interval between the inner layer protection pattern 25 and the outer shape line DL 2 is set widely, it is possible to avoid causing damage to the flexible portion 22. That is, the periphery of the covering portion 58 (the portion of the outer layer material 50 that corresponds to the inner layer protection pattern 25, and is severed by the laser beam LS) is located outside of the outer shape line DL 2, so even when damage is caused by a peeling jig (for example, a cutter knife) or the like at the peeling start end (periphery of the covering portion 58) where peeling is started when peeling away the covering portion 58, there is rarely an instance in which damage reaches inside of the outer shape line DL 2. Also, this damage is removed in the outer shape formation process, so the exterior state of the completed component is good.

Also, before peeling away the covering portion 58, a peeled portion (not shown) may be formed in which the flexible portion 22 and the covering portion 58 have been separated by peeling, such that peeling can be easily started. Specifically, a peeled portion is formed in which by pressing against and pulling up the end edge (portion severed by the laser beam LS) of the covering portion 58 with a cutter knife or the like, a portion of the end edge of the covering portion 58 is separated by peeling. Thus, it is possible to begin peeling away the covering portion 58 from the peeled portion, so it is possible to more simply begin peeling away the covering portion 58.

Also, before peeling away the covering portion 58, a through-hole (a hole that passes through the outer layer material 50 and the core substrate 1, not shown) may be formed as a peeling start in the end edge of the covering portion 58 of the layered substrate 2. For example, such a through-hole may be formed with a press die or illumination of the laser beam LS. When a through-hole is formed with the laser beam LS, a broken portion (that is, a portion where the inner layer protection pattern 25 is not present) is formed in the inner layer protection pattern 25 in advance, and when the laser beam LS has been irradiated on the outer layer material 50 of the inner layer protection pattern 25, a through-hole is formed by allowing the laser beam LS to pass through in the broken portion. That is, in the broken portion the inner layer protection pattern 25 is not present and so it is easy for the laser beam LS to pass through. Thus it is possible to form a through hole at the same time in the process in which the laser beam LS is irradiated. In the cross-section of a through-hole that has been formed in this manner, the border where the covering portion 58 and the flexible portion 22 are in contact appears, and so it is possible to start peeling away the covering portion 58 from this border by inserting a tweezer with a thin pointed end.

Also, a peeled portion or a through-hole may be formed in a subsequent electrical testing process with a jig or the like immediately before performing electrical testing. By, in this manner, forming a peeled portion with a cutter knife, a jig, or the like, or forming a through-hole with the laser beam LS, a press die, a jig, or the like, it is possible to more reliably and simply form a peeled portion or a through-hole. Also, the efficiency of the chain of work that removes the covering portion 58 is thus improved.

Next, electrical testing is performed in state with the outer frame 93 left remaining. In a conventional production method, the flexible portion 22 does not appear in the surface if the outer shape is not formed, so electrical testing is performed only after the outer shape has been formed. However, in the present embodiment, the flexible portion 22 appears in the surface before the outer shape is formed, so electrical testing is possible in a state with the outer frame 93 left remaining. Thus, electrical testing can be performed in a state in which the flexible portion 22 is held by the outer frame 93, so because there is no bending or damage given while performing work, yield improves. Also, work to arrange in an electrical tester smoothly proceeds, improving work efficiency.

Next, shearing processing is performed along the outer shape line DL 2 with a die, forming an outer shape (outer shape formation process), and a multilayer printed wiring board 3 is completed.

In the present embodiment, the multilayer printed wiring board 3 with three layers was described, but the present embodiment can be applied in a multilayer printed wiring board that has two or more layers.

### Embodiment 2

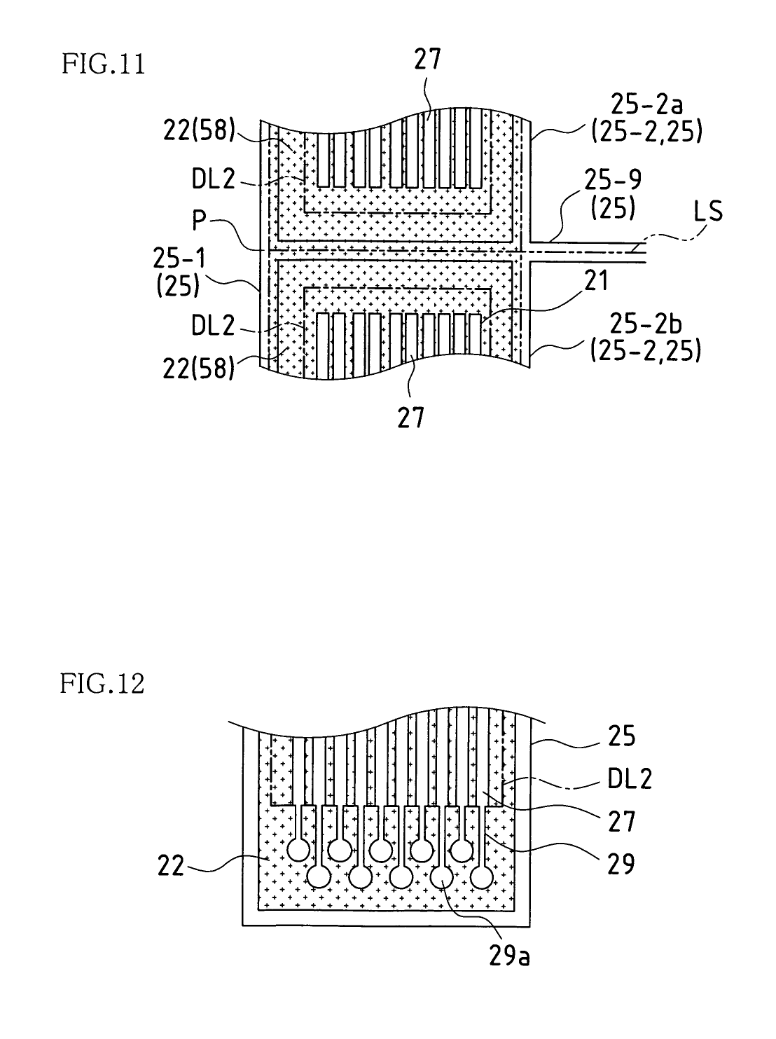

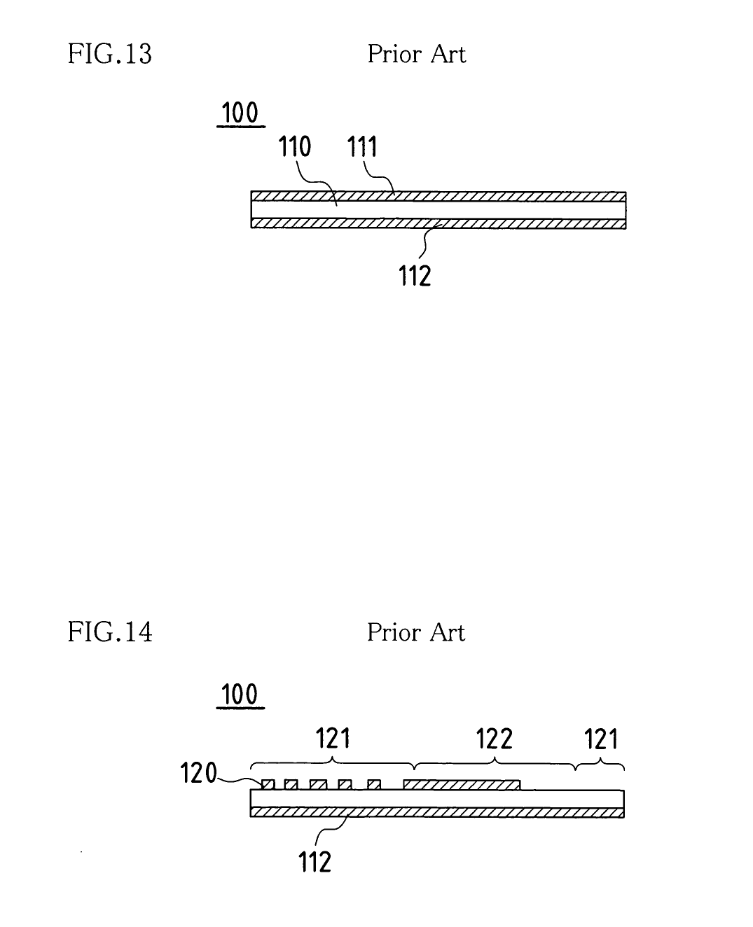

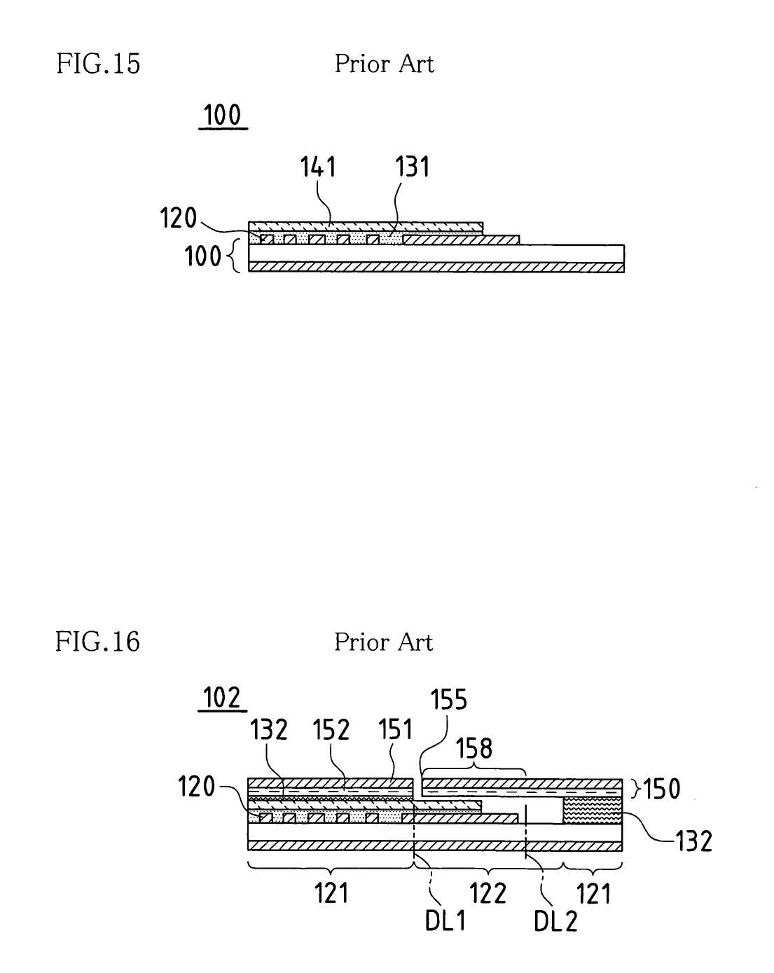

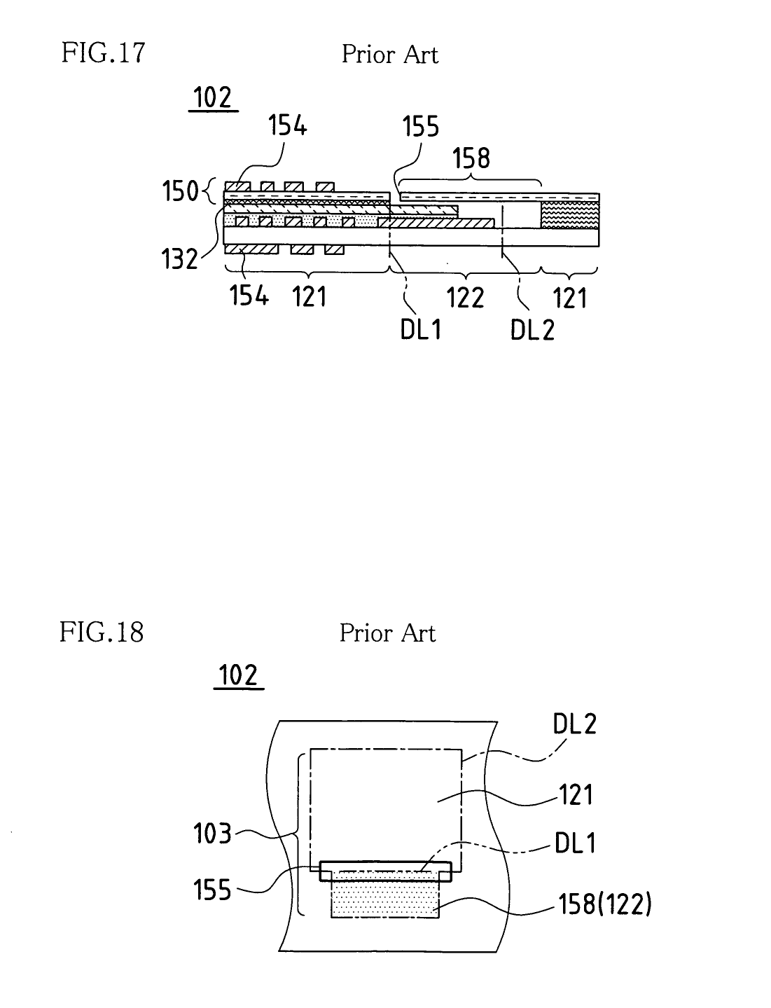

In the present embodiment, a production method in which a plurality of multilayer printed wiring boards are produced from one core substrate will be described with reference to FIGS. 1 to 11 (particularly FIGS. 10 and 11). The main production process is essentially the same as in Embodiment 1, and so a description thereof is omitted here.

FIG. 10 is a top view of a core substrate in a state in which a plurality of inner layer patterns have been formed, in a method for producing a multilayer printed wiring board according to Embodiment 2 of the present invention. In order to form a plurality of the multilayer printed wiring boards 3 from one core substrate 1, the core substrate 1 is divided into a plurality of work regions (regions in which a multilayer printed wiring board 3 will be formed). For example, one core substrate 1 is divided into four horizontal rows and two vertical rows, and eight multilayer printed wiring boards 3 are formed at the same time from a total of eight divisions.

In each division, respective inner layer patterns 20 are formed, a coverlay film 41 is layered, the outer layer material 50 is layered, the outer layer pattern 54 is formed, severing is performed by irradiating laser beams LS at the periphery of the covering portion 58 that corresponds to the flexible portion 22 (the shaded region in FIG. 10) (lines 25-1 to 25-9 corresponding to the inner layer protection pattern 25), the covering portion 58 is removed by starting peeling from a portion P where the laser beams LS intersect, and lastly shearing is performed along the outer shape line DL 2, thus forming a multilayer printed wiring board 3. Each process is the same as in Embodiment 1, so a description thereof is omitted here. Here is a description the arrangement of the inner layer protection pattern 25 formed in each division, and the effects of performing severing by irradiating a laser on the line of the outer layer material 50 that corresponds to the inner layer protection pattern 25, after layering the outer layer material 50.

FIG. 11 is an enlarged view of adjacent portions of a multilayer printed wiring board that have been disposed vertically in FIG. 10. The inner layer protection pattern 25, same as in Embodiment 1, is provided at the peripheral edge of the flexible portion 22, and is formed such that it surrounds the outside of the outer shape line DL 2. The present embodiment differs from Embodiment 1 in that a portion of adjacent inner layer protection patterns 25 is shared.

In the present embodiment, one core substrate 1 is divided into four horizontal rows and two vertical rows, the flexible portions 22 are arranged facing each other vertically, and a portion of vertically adjacent inner layer protection patterns 25 is shared. Also, among the vertically adjacent inner layer protection patterns 25, approximately vertically arranged portions 25-2a and 25-2b are arranged in a straight line in the shared inner layer protection pattern 25-9.

Thus, in order to remove the covering portion 58 that corresponds to the flexible portion 22 after bonding the outer layer material 50, when scanning the laser beam LS along the inner layer protection pattern 25, the pass process for irradiation of the laser beam LS is a nine pass process (FIG. 10: 25-1 to 25-9). That is, when there is no sharing in the inner layer protection pattern 25, a three pass process (FIG. 10: one division for 25-1, one division for 25-9, one division for 25-2) is necessary in each division in order to perform severing with the same shape in each division. In the present embodiment there are eight divisions so a total of 24 pass processes are necessary, but by forming a shared inner layer protection pattern 25, it is possible to effectively scan the laser beam LS without going through a plurality of pass processes in this manner, and the time for sever processing can be shortened.

When removing the covering portion 58, when peeling away is started from the shared portion (for example, P in FIG. 10) of the inner layer protection pattern 25, the adjacent covering portion 58 is peeled away into a double door-like form, and the covering portion 58 can be effectively removed.

It is preferable that, same as in Embodiment 1, it is preferable to form a peeled portion (or a through-hole) as a peeling start in the shared portion of the inner layer protection pattern 25 with a jig or the like. Thus, it is possible to more effectively perform the peeling away work.

Also, in the present embodiment, eight of the multilayer printed wiring boards 3 are formed at the same time, but in the electrical testing process, there may be instances when eight of the multilayer printed wiring boards 3 are not dealt with at the same time. In such a case, the layered substrate 2 is for example divided into two before the process for removing the covering portion 58. Also, when dividing, a peeled portion (or a through-hole) may be formed as a peeling start.

Specifically, a hole-punching portion is provided in advance in a dividing device, and at the same time as division of the layered substrate 2 a through-hole is formed in the shared portion of the inner layer protection pattern 25. Thus, it is possible to form a through-hole as a peeling start for removing the covering portion 58 at the same time as division of the core substrate 1. Therefore, the process for forming a through-hole can be omitted, and the manufacturing process can be simplified.

### Embodiment 3

FIG. 12 is an enlarged view of the vicinity of terminals that have been provided in a flexible portion, in a method for producing a multilayer printed wiring board according to Embodiment 3 of the present invention. In the present embodiment, the pattern of card edge-type terminals 27 is formed in the flexible portion 22 (the shaded region in FIG. 12) as the inner layer pattern 20. The main production process is essentially the same as in Embodiments 1 and 2, and so a description thereof is omitted here. The card edge-type terminals 27 are card-type terminals 27 in which a connection is made by being inserted in a connector or the like.

The pattern of the card edge-type terminals 27 is configured such that the line width of each terminal 27 is narrow, and with a plurality of the terminals 27 provided parallel to each other with fine spacing. The outer shape line DL 2, which defines the outer shape of the completed component (the multilayer printed wiring board 3) is provided such that it overlaps the front ends of the terminals 27. That is, the card edge-type terminals 27 are caused to extend outward to the end edge of the outer shape as much as possible, in order to be allowed to reliably make contact with the connector-side terminals 27 when inserted into the connector.

A testing pattern 29 is formed at the front end of the terminals 27 by extending out respective conducting wires. That is, the testing pattern 29 is formed outside of the outer shape line DL 2, and removed when forming the outer shape line. Thus, it is possible to reduce the size of the outer shape of the completed component. As a result, it is possible to choose a probe pin having an appropriately suitable size, and it is possible to stably and swiftly perform electrical testing.

That is, when the testing pattern 29 is provided inside the outer shape line DL 2, it is necessary to reduce the size of the testing pattern 29, so it is necessary to reduce the size of the probe pin used for electrical testing. Also, when a probe is placed in contact with the pattern or terminal directly without forming the testing pattern 29, and pattern width of the tested portion is narrow, it is necessary to use a small probe pin. The durability of a small probe pin is poor, so there is the problem that it is changed with high frequency. Also, there is the problem that because contact resistance or the like with the tested object is high, stability, speed and reliability of testing are poor. Moreover, precise positioning is necessary when testing a high density pattern, so there is the problem that stability, speed and reliability of testing are poor. However, by providing the testing pattern 29 outside of the outer shape line DL 2 restrictions on the size of the testing pattern 29 are alleviated, so the testing pattern 29 can be set to an appropriate size, and thus, it is possible to use a probe pin that has an appropriately suitable size. As a result, it is possible to reduce exchanges of the probe pin, and testing can be performed stably and swiftly.

Also, the lands 29a of the testing patterns 29 are arranged staggered relative to each other. The diameter of the lands 29a is approximately the same as or somewhat larger than the thickness of the front end of a durable probe pin. The staggered arrangement may have two or more levels, depending on the size of the lands 29a.

The periphery of the terminals 27 and the testing patterns 29 is surrounded by the inner layer protection pattern 25. That is, when the covering portion 58 is peeled away, the terminals 27 and the testing patterns 29 appear in the surface. Thus, the probe of an electrical tester can be placed in contact with a testing pattern 29, and electrical testing of the inner layer pattern 20 can be performed before removing the outer frame 93. Also, because the probe pin is not placed in direct contact with the terminals 27, terminals are not damaged.

The present invention may be embodied in various other forms without departing from the gist or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A method for producing a multilayer printed wiring board,
the method comprising an inner layer formation step of forming an inner layer pattern in a core substrate divided corresponding to a flexible portion that is made bendable and a hard portion that is made rigid, and an outer layer formation step of forming an outer layer such that an outer layer material that covers the core substrate is caused to make contact at the hard portion, and an outer layer pattern formation step of forming an outer layer pattern in the surface of the outer layer material, and a removal step of removing a covering portion that is the outer layer material and is covering the flexible portion, and an outer shape formation step of forming the outer shape of a layered substrate formed via the removal step, wherein:
an inner layer protection pattern is formed in the periphery of the flexible portion before the outer layer formation step, and
the method comprises a step of severing the periphery of the covering portion by irradiating a laser beam on the outer layer material that corresponds to the inner layer protection pattern before the removal step.

2. The method for producing a multilayer printed wiring board according to claim 1,
wherein the inner layer protection pattern is formed along with the inner layer pattern in the inner layer formation step.

3. The method for producing a multilayer printed wiring board according to claim 1 or claim 2,
wherein the inner layer protection pattern is provided outside an outer shape line that defines the outer shape.

4. The method for producing a multilayer printed wiring board according to claim 3,
wherein in the inner layer formation step, a testing pattern is formed between the inner layer protection pattern and the outer shape line.

5. The method for producing a multilayer printed wiring board according to claim 1,
wherein in the outer layer formation step, an outer layer guide pattern parallel to a border of the hard portion and the flexible portion is formed in one or both of a side of the hard portion and a side of the flexible portion.

6. The method for producing a multilayer printed wiring board according to claim 5,
wherein the outer layer protection pattern is formed along with the outer layer pattern in the outer layer formation step.

7. The method for producing a multilayer printed wiring board according to claim 1,
wherein before the removal step, a peeled portion is formed in which the flexible portion and the covering portion have been separated by peeling.

8. The method for producing a multilayer printed wiring board according to claim 1,
wherein electrical testing is performed before the outer shape formation step.

9. The method for producing a multilayer printed wiring board according to claim 1,
wherein a plurality of the inner layer patterns are formed, and the inner layer protection pattern for each inner layer pattern is formed such that a portion is shared among adjacent inner layer protection patterns.
